(19) United States
(12) Patent Application Publication
(10) Pub. No.: US 2007/0102647 A1
(43) Pub. Date: May 10, 2007

(54) Multi-radiation large area detector

(75) Inventors: Jacqueline A. Johnson, Woodridge, IL (US); Richard Weber, Arlington Heights, IL (US); Stefan Schweizer, Paderborn (DE); Douglas R. MacFarlane, Brighton East Victoria (AU); Peter Newman, Brighton Victoria (AU); Gang Chen, Woodridge, IL (US)

Correspondence Address: HARRY M. LEVY;OLSON & HIERL, LTD., 20 North Wacker, 36th Floor, CHICAGO, IL, 60606-4401, US

(73) Assignee: The University of Chicago, Chicago, IL (US)

(21) Appl. No.: 11/267,056

(22) Filed: Nov. 4, 2005

(51) Int. Cl. G01T 3/06

(52) U.S. Cl. 250/390.11

(57) ABSTRACT

A radiation detector having glass emitting photons by scintillation in response to incident neutrons and/or electromagnetic radiation of at least about 1 keV, and a system associated with the glass for detecting the presence of photons emitted by scintillation. The glass ceramic material is a fluoride glass matrix having nanocrystalline particles distributed therein substantially all of which are in a phase that scintillates with average diameters of less than about 100 nm in a fluorozirconate matrix. Various metals are disclosed for the ceramic particles and methods of manufacture are also disclosed.

The United States Government has rights in this invention pursuant to Contract No. W-31-109-ENG-38 between the U.S. Department of Energy and The University of Chicago representing Argonne National Laboratory.

### FIELD OF THE INVENTION

This invention relates to sensor materials and a method for detecting ionizing radiation and neutrons by converting the incident radiation to visible light that is detected with an optical detector such as a camera or silicon photodiode.

### BACKGROUND OF THE INVENTION

The materials that are the subject of this invention are substantially glass such as those disclosed in U.S. Pat. No. 6,352,949, issued to Williams et al. Mar. 5, 2002, the entire disclosure of which is incorporated by reference, that is doped with sensitizers including ions of the rare earth element such as europium as well as others as will be disclosed and ions of elements that are sensitive to neutrons such a isotopically enriched lithium-six. The materials can be fabricated into glasses that can be made in various forms including plates, arrays of plates and shaped articles such as hollow cylinders or solid rods. The sensors are of use in medical imaging where high resolution is required, in detecting radiation sources for security applications such as cargo and freight inspection and scanning individuals at ports of entry, airports, etc. In addition the materials are of use in imaging and data acquisition systems for beamlines and testing facilities that use radiation as a probe tool.

### SUMMARY OF THE INVENTION

Accordingly, it is an object of the invention to provide a radiation detector, comprising a glass emitting photons by scintillation in response to incident neutrons and/or electromagnetic radiation of at least about 1 keV, and a system associated with the glass for detecting the presence of photons emitted by scintillation.

Another object of the invention is to provide a glass ceramic material capable of scintillation upon incident neutrons and/or electromagnetic energy of at least 1 keV comprising a fluoride glass matrix having nano-crystalline particles distributed therein substantially all of which are in a phase that scintillates.

A final object of the invention is to provide a method for making a glass-ceramic material containing nano-crystalline particles with average diameters of less than about 100 nm in a fluorozirconate matrix, comprising mixing ZrF₄, an alkali fluoride, an alkaline earth fluoride, a fluoride of a tri-valent metal selected from the group consisting of transition metal ions, rare earth metal ions, In ions, Ga ions, Tl ions, Pb ions and mixtures thereof, together with a bromide/chloride compound selected from the group consisting of alkali and alkaline earth bromides/chlorides, such that zirconium fluoride is present in a concentration of at least 35 mole % and bromide/chloride ions are present in a concentration of at least 5 mole % in the glass-ceramic, heat treating the fluorozirconate matrix at a temperature and for a time sufficient such that substantially all of the nano-crystalline particles are in a phase that scintillates, and thereafter cooling the mixture to room temperature.

### BRIEF DESCRIPTION OF THE DRAWINGS

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

FIG. 1 is a schematic diagram illustrating the implementation of a multilayer glass detector;

FIG. 2 is a representation of a tiled “mosaic” of sensitive glass plates arranged to provide a large area detector;

FIG. 3 is a schematic representation of experimental apparatus used at the Advanced Photon Source to study scintillation effects in the glasses;

FIGS. 4(a) and (b) are Eu-doped glass (4b) and commercial single crystal cadmium tungstate (4a). The dark lines result from blocking of the x-rays by gold lines on the test mask. The widths of the lines are 100, 50, 20 10, 5, 2 and 1 micron marked on the image;

FIGS. 5(a) and (b) are mouse foot joints taken by Eu-doped glass ceramic (5b) and commercial single-crystal cadmium tungstate (5a) under identical x-ray imaging conditions; and

FIG. 6 is like FIG. 1 for curved or arcuate surfaces.

### DESCRIPTION OF THE PREFERRED EMBODIMENT

This invention relates to solid-state radiation detectors that are sensitive to a wide range of electromagnetic radiation energies from x-ray to gamma ray (approximately 1 keV to 10 MeV or more) and/or sensitive to neutrons. More specifically the invention relates to low-cost solid-state radiation detectors that are based on glass. Solid state detectors have been developed that are separately sensitive to narrow ranges of the electromagnetic spectrum or to neutrons, but none is available that have a wide sensitivity range which may include neutrons. This invention further relates to the use of glass as the medium for the active detector materials that can be incorporated separately or together. The glass can be formed into sheets that can be fabricated even into large area detectors of the types that are envisioned for scanning of large objects such as trucks and cargo containers for security applications.

The invention includes a solid-state detector that is simultaneously sensitive to electromagnetic radiation over a wide spectrum of energies and/or sensitive to neutrons. The invention is a new class of high-resolution imaging detectors based on glass-ceramic plates that emit visible light in response to irradiation by ionizing radiation such as x-rays or gamma rays and/or irradiation by neutrons. The emitted light can be detected using silicon-based photodetectors or video imaging that is inexpensive and can be made using either standard or custom components. An important difference between the invention and the prior art is that the present invention discloses that the light may be directly emitted by scintillation, rather a stored and then released by photostimulated luminescence (PSL). The use of scintillation enables a simpler detector system that does not require a light source to develop PSL and does not require “bleaching” to eliminate residual PSL before the plate is ready to detect again.

The detectors of this invention have applications as medical x-ray detectors in that they provide fine resolution because the material is optically homogeneous. In medical applications, the use of these detectors can permit the detection of abnormalities in the body at an early stage when they are very small, having a strong impact on preventive medicine. These detectors also have a place in homeland security because of the ease of scaling up the detectors to cover a large area, either by forming large sheets of glass or tiling multiple flat or contoured pieces. These detectors are also of use in connection with scientific research applications of electromagnetic radiation and particles such as x-ray tomography for examination of structural components.

The invention combines desirable features of glass products—ease of fabrication, low production cost, scalablity, and detectivity and sensitivity to various types of radiation.

X-ray detection technology includes, film, image intensified video cameras, flat panel detectors based on semiconductors or selenium, sodium iodide doped with thallium, mercuric iodide-based sensors, and PSL storage phosphors based on polycrystalline materials. The current approaches have well recognized limitations: film is one-use, expensive, time consuming and subject to improper exposure. Video camera chains are subject to improper alignment and susceptible to image distortion and have limited sensitivity ranges. Amorphous silicon flat panels have poor resolution and are susceptible to image distortion. Photoconductor flat panel detectors such as systems based on amorphous selenium have proved to be unstable, have low x-ray sensitivity and must be operated at extremely high voltage. Mercuric iodide has high x-ray sensitivity but must be deposited on a substrate as a single crystal, which is time consuming, expensive and limits the size of detector that is practical. Further, the prior art techniques are limited to narrow ranges of detectivity that limit their application in cases where the energies are not predetermined and fixed.

In an effort to extend capabilities for x-ray imaging, storage phosphors based on polycrystalline materials and on glass-based materials have been widely investigated. In these products, the storage principle is that incident x-rays generate electron-hole pairs, which are separately trapped and are stable at room temperature. Recombination of the electron and the hole can be initiated by exposure of the material to a visible wavelength corresponding to the absorption band of the electron. The recombination energy is transferred to a doped activator, such as a rare earth ion, and a higher energy luminescence of the activator is observed. Exposure of the detector to a light source of appropriate frequency could neutralize the detector allowing for reuse. The invention utilizes a fluoride-based proprietary glass composition described in the '949 patent to which various metallic ions have been added to increase sensitivity to a range of electromagnetic energies. For example test samples of about 2% Eu²⁺ and Br/Cl-doped zirconium fluoride-based formulations have been shown to detect x-rays in the 15 keV range. The effectiveness of the glass as a detector is controlled via the composition and processing method including heat treatment temperature and times as described herein. These detectors may be extended to allow detection of higher energy radiation such as gamma rays.

Glass-based detectors of the invention can detect neutrons by the addition of sensitizers that respond to neutron irradiation by emission of visible light, by doping with lithium-six.

### EXAMPLE 1

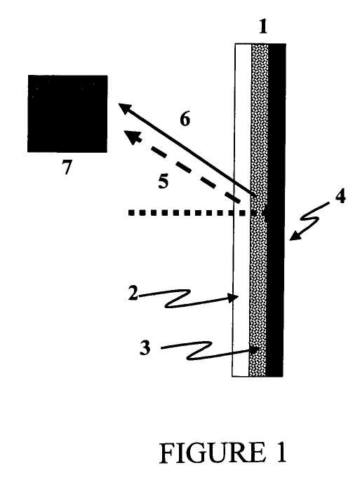

One embodiment of the invention is shown in FIG. 1. An incident radiation signal enters the composite glass plate 1, where the plate consists of 2 or more layers of glass each sensitized to respond to a particular radiation energy band. The first layer of the plate, 2, responds to the lowest energy (i.e. least penetrating) radiation. The second layer of the plate, 3, responds to more penetrating radiation than the first. Such a system can be made in multiple layers with a reflective backing, 4. An example of a material that would be suitable as a reflective backing for visible light is metallic aluminum, which can be vapor deposited. Other options include gold and silver, however, silver can tarnish and gold is expensive. Also dielectric layer reflectors may be used to achieve high reflectivity at selected wavelengths or allow filtering of the light wavelengths. Use of dielectric reflectors such as MgF₂ in optics manufacture and such coatings can readily be applied by standard techniques used in the industry. Ideally, the number of layers is minimized by using materials with a broad response range.

In response to the incident radiation, the sensor glass emits a photon or photons that are characteristic of the detecting medium. The emitted photons are indicated as 5 and 6. The emitted photons are detected by an optical system that may be a photon counting device or a spatially resolved imaging device such as a video camera, 7. The camera was a Photometric Coolsnap cooled CCD camera equipped with a Zeiss lens that enables resolution of ca. 1 micron in imaging the scintillation. The mask used to test resolution consisted of a custom-made gold on silicon plate with the thinnest line being 1 micron.

The detection signal is provided to an operator either as a raw signal or may be automatically processed.

### EXAMPLE 2

A glass sensor plate, in which the glass is simultaneously sensitized to radiation over a broad range of energies by using multiple sensitizers in a single layer of glass.

### EXAMPLE 3

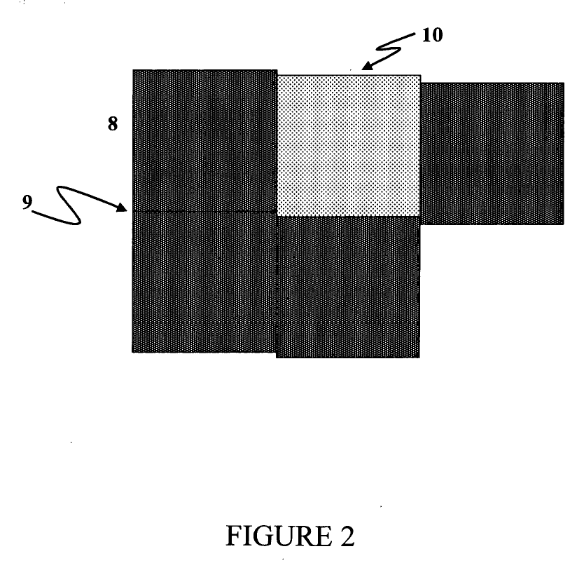

A large area glass sensor that comprises more than one smaller piece of glass that is tiled in a “mosaic” to form a larger sensitive area. Each tile may be single layer or multi-layered. Combinations of single and multi-layered tiles may be put together to achieve spatially differentiated sensitivity on a single detector. FIG. 2 illustrates the arrangement in which the tiles 8 and 10, are joined to form a single large area of sensitive material. The boundaries between the tiles can be joined simply by placing them together in a frame or other support structure so that the edges of the tiles are close to each other without gaps. Alternative configurations bond the glass with a material with similar refractive index to the glass. The Cargille Laboratories, Cedar Grove, N.J. makes index matching oil-based materials that would be suitable for making an index matched joint 9. Alternatively, in some cases glass plates may be fused together by heating the glass above the glass transition temperature into the supercooled liquid region where the materials will weld together to form a seamless component that can be locally finished by polishing or grinding.

### EXAMPLE 4

A glass sensor made from a glass comprising a mixture of metal halides that include at least some europium difluoride (EuF₂) that is sensitive to x-ray stimulation. Examples of composition that may be used are given in Table 1 below.

TABLE 1
Base sample compositions and identification (ID). Values are in mole %.

| ID | ZrF₄ | BaF₂ | BaCl₂ | BaI₂ | NaF | NaBr | NaCl | NaI | LaF₃ | AlF₃ | YF₃ | InF₃ | EuF₂ |
|---|---|---|---|---|---|---|---|---|---|---|---|---|---|
| Z-1 | 51 | 20 | — | — | 5 | 15 | — | — | 1.5 | 3 | 1.5 | 1.0 | 2 |
| Z-2 | 51 | 15 | 5 | — | — | 20 | — | — | 1.5 | 3 | 1.5 | 1.0 | 2 |
| Z-3 | 51 | 10 | 10 | — | — | 20 | — | — | 1.5 | 3 | 1.5 | 1.0 | 2 |
| Z-4 | 48 | 20 | — | — | 5 | 15 | — | — | 1.5 | 3 | 1.5 | 1.0 | 5 |
| Z-5 | 43 | 20 | — | — | 5 | 15 | — | — | 1.5 | 3 | 1.5 | 1.0 | 10 |
| Z-6 | 51 | 20 | — | — | 5 | 15 | | — | 3.5 | 3 | — | 0.5 | 2 |
| Z-7 | 51 | 15 | 5 | — | — | — | 20 | — | 3.5 | 3 | — | 0.5 | 2 |
| Z-8 | 51 | 10 | 10 | — | — | — | 20 | — | 3.5 | 3 | — | 0.5 | 2 |
| Z-9 | 48 | 10 | 10 | — | — | — | 20 | — | 3.5 | 3 | — | 0.5 | 5 |
| Z-10 | 43 | 10 | 10 | — | — | — | 20 | — | 3.5 | 3 | — | 0.5 | 10 |
| Z-11 | 51 | 20 | — | — | 5 | — | — | 15 | 1.5 | 3 | 1.5 | 1.0 | 2 |
| Z-12 | 51 | 15 | — | 5 | — | 20 | — | — | 1.5 | 3 | 1.5 | 1.0 | 2 |
| Z-13 | 51 | 10 | — | 10 | — | 20 | — | — | 1.5 | 3 | 1.5 | 1.0 | 2 |
| Z-14 | 48 | 20 | — | — | 5 | — | — | 15 | 1.5 | 3 | 1.5 | 1.0 | 5 |
| Z-15 | 43 | 20 | — | — | 5 | — | — | 15 | 1.5 | 3 | 1.5 | 1.0 | 10 |

### EXAMPLE 5

A glass plate that is sensitive to x-rays and gamma rays where the glass has been processed to accomplish one or more of the following:

1. Eu (II) doped ZBLAN heavy metal fluoride glass (see the '949 patent) with partial replacement of F with Br.

2. Eu (II) doped ZBLAN heavy metal fluoride glass with partial replacement of F with Cl.

3. Eu (II) doped ZBLAN heavy metal fluoride glass with replacement of Na with Cs and Li and partial replacement of F with Br and/or Cl.

Additional sensitizers that may be added singly or additively to achieve, enhance or modify the response to radiation are all the metals listed hereafter in Table II, but preferably In⁺, Ga⁺, Tl⁺, Sm³⁺, Li⁺, and/or Ce³⁺. The sensitizers may be added singly or in groups that enable enhanced detection ranges.

A specific example of the preparation of a glass that includes a specialized heat treatment to achieve the desirable response of scintillation properties is given below

The glass melt comprised 2.937 g of zirconium tetrafluoride, 0.237 g of lanthanum fluoride, 0.084 g of aluminum fluoride and 0.278 g of sodium fluoride are placed in a platinum crucible. 0.057 g of indium fluoride is added in order to control the reduction of zirconium (IV) species to zirconium (III). The crucible is then placed in a suitable furnace under an atmosphere of high purity argon. The fluoride powders are firstly dried at 400 degrees Celsius for 1 hour and then the temperature of the furnace is raised to 800 degrees Celsius. The fluoride powders are held at 800 degrees Celsius for a further three quarters of an hour in the high purity argon atmosphere. The melt is then oxidized by changing the argon atmosphere from pure argon to 25% oxygen in argon. The melt is oxidized in the oxygen/argon atmosphere for a further 15 minutes. The crucible is then removed from the furnace and quenched. A white heavily crystallized disc is obtained. 1.380 g of barium chloride and 0.037 g of europium (II) chloride is then added to the platinum crucible containing the heavy metal fluoride disc. These masses give a target composition expressed in mole percent of 53 mol % ZrF₄, 20 mol % BaCl₂, 3.65 mol % LaF₃, 3 mol % AlF₃, 20 mol % NaF and 0.35 mol % EuCl₂. The temperature of the furnace is then lowered to 750 degrees Celsius and the platinum crucible is placed back into the furnace. The combined fluoride/chloride melt is held at 750 degrees Celsius for 1 hour in a high purity argon atmosphere. The melt is then removed from the furnace and cast into a brass mould preheated to 200 degrees Celsius. The glass is now annealed at 200 degrees Celsius for 3 hours after which the temperature of the mould is raised to 235 degrees Celsius. The glass is held at 235 degrees Celsius for 10 hours and then cooled to room temperature over 15 hours.

In the double anneal the first step at 200 degrees Celsius can be for any period of time. This temperature is lower than the glass transition temperature and Tₓ₃, the crystallization event that gives rise to the new crystalline phase in these materials. The temperature is then quickly raised to 235 degrees Celsius. The time at 235 degrees Celsius can be from 30 minutes to more than 40 hours in order to grow the hexagonal BaCl₂. There is a time/size dependence as well as an intensity/time dependence at this stage. The particles grow with increasing time up to 20 hours and the number of particles increases up to 10 hours and then becomes constant.

As long as the temperature is kept below 235 degrees Celsius in order to prevent the transformation of hexagonal to orthorhombic, the glass can be annealed in any number of ways. For example, 200 degrees Celsius from about 1 hour to 30 hours, 210 degrees Celsius or 220 degrees Celsius or 230 degrees Celsius from about 2 hours to 40 hours and 235 degrees Celsius from about 30 minutes to 40 hours.

The heat treatment of the glass achieves desirable changes in the structure of the materials and “ripens” the components of the glass that achieve scintillation by interaction of the europium fluoride with x-rays or gamma rays.

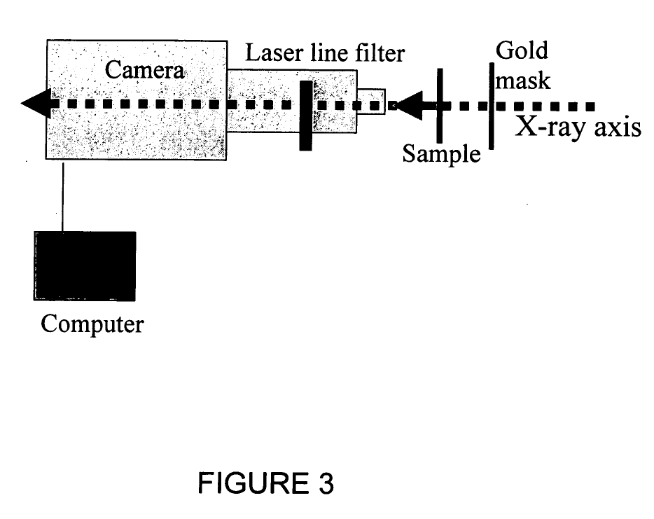

FIG. 3 shows the experimental set up used to investigate scintillation effects in the glasses of the present invention.

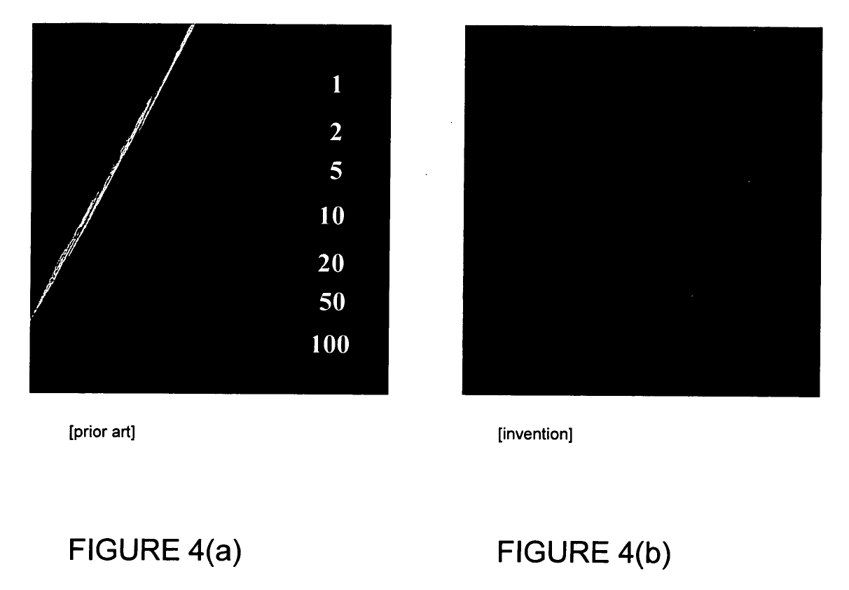

An example of the response of a scintillator glass processed as described above is shown in FIG. 4(b), whereas FIG. 4(a) shows a state of the art single crystal cadmium tungstate scintillator for comparison.

### EXAMPLE 6

The glasses of example 4 wherein at least part of the glass formulation has been replaced with ⁶Li₂F (lithium fluoride made with isotopically enriched lithium 6, such materials are available from Cambridge Isotope Laboratories) that can interact with neutrons to produce an excited helium atom, shown as He* in the equation below.
⁶Li+¹n=³H+⁴á+2e⁻[He*]
He*+Ce³⁺=He+Ce³⁺*=He+Ce³⁺+hí
Visible light is produced by interactions between excited helium atoms and trivalent cerium ions. The glass can readily incorporate the cerium ions that would be added as CeF₃.

In order to detect neutrons, it is necessary that they are “stopped” by the sensitizer and interact to result in light. It is possible for very high energy, fast neutrons to penetrate the material without interacting to produce evidence of their presence. In order to slow neutrons down, a moderator such as a polythene film can be used.

### EXAMPLE 7

The inventive glasses exhibit high scintillation efficiency comparable to that of single crystal materials in the x-ray energy range from about 1-20 keV. The output of light increases exponentially with increasing x-ray photon energy. Thus output from high-energy radiation, such as short wavelength, high energy x-rays and gamma rays, is large, enabling high sensitivity to the radiation sources that emit in this band. Glasses of the invention should emit photons by scintillation for energies up to about 100 MeV and from neutrons of at least 0.0025 eV.

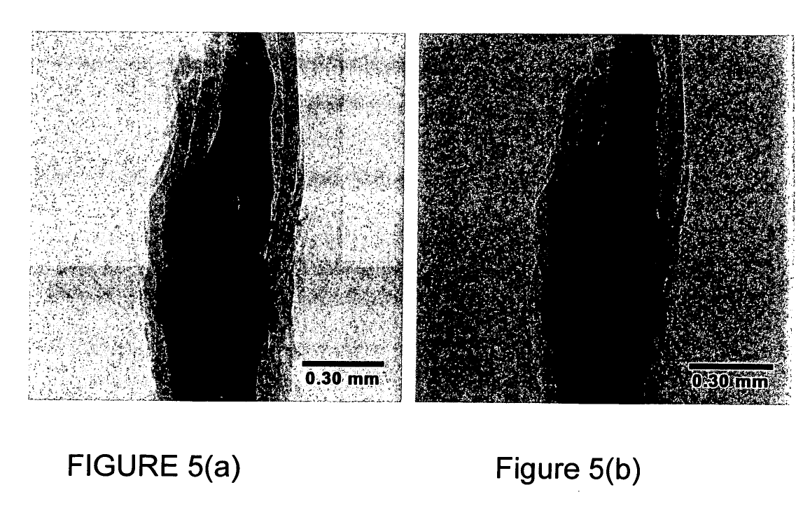

FIGS. 5(a) and 5(b) compare imaging resolution for the prior art single crystal, 5(a), and the invention, 5(b). The figures show that these two x-ray scintillators have almost the same imaging resolution. The Eu-doped glass-ceramic scintillator has some other advantages such as being sensitive to neutron radiation. It's potential for arbitrary shapes and sizes at a much lower cost than cadmium tungstate also makes it attractive. Glasses can easily accommodate other components that can alter spectral range and lifetime of the rare earth activator. The inventive glass has comparable performance to cadmium tungstate and a lot more versatility.

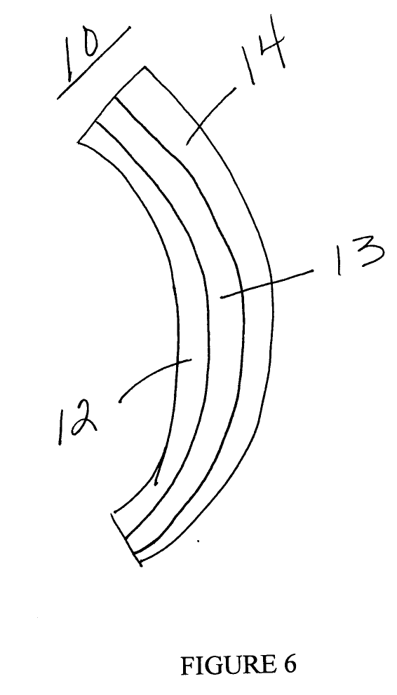

FIG. 6 shows that the invention may be easily formed into a variety of arcuate shapes, such as but not limited to hollow cylinders and rods. Ease of fabrication is an important aspect of the invention.

In addition to the metals listed in Table 1, a variety of other metals may be incorporated into the inventive glass in a wide variety of mixtures or singly, so long as the phases maintain scintillation.

Table II sets forth all the known metals useful as sensitizes for scintillation glasses.

TABLE II

Other Metals
Aluminum
Gallium
Indium
Tin
Thallium
Lead
Bismuth
Transition Metals
Scandium
Titanium
Vanadium
Chromium
Manganese
Iron
Cobalt
Copper
Nickel
Zinc
Yttrium
Zirconium
Niobium
Molybdenum
Technetium
Ruthenium
Rhodium
Palladium
Silver
Cadmium
Hafnium
Tantalum
Tungsten
Rhenium
Osmium
Iridium
Platinum
Gold
Mercury
Rare Earth Metals
Lanthanum
Cerium
Praseodymium
Neodymium
Promethium
Samarium
Europium
Gadolinium
Terbium
Dysprosium
Erbium
Thulium
Ytterbium
Lutetium
Holmium

As seen therefore, there has been described a glass-ceramic material in which nanocrystalline particles having average diameters of less than about 100 nm and preferably less than about 20 nm have been disclosed. The nanocrystalline particles are substantially in a phase that maintains scintillation, which for BaCl₂

in the hexagonal phase, and produce photons in response to incident neutrons of at least 0.0025 eV and/or electromagnetic radiation of at least 1 keV and up to about 100 MeV, while incident electromagnetic radiation of up to about 20 keV is common.

While there has been disclosed what is considered to be the preferred embodiments of the present invention, it is understood that various changes in the details may be made without departing from the spirit, or sacrificing any of the advantages of the present invention.

The embodiments of the invention in which an exclusive property or privilege is claimed are defined as follows:

1. A radiation detector, comprising a glass emitting photons by scintillation in response to incident neutrons and/or electromagnetic radiation of at least about 1 keV, and a system associated with said glass for detecting the presence of photons emitted by scintillation.

2. The radiation detector of claim 1, wherein said glass emits photons by scintillation in response to incident radiation of up to 100 MeV.

3. The radiation detector of claim 1, wherein said glass emits photons by scintillation in response to incident radiation of up to 20 keV.

4. The radiation detector of claim 1, wherein said glass emits photons by scintillation in response to incident neutrons of at least 0.0025 eV.

5. The radiation detector of claim 1, wherein said glass is a plurality of layers in substantial registry, each layer emitting photons by scintillation in response to incident neutrons and/or electromagnetic radiation of different energy levels.

6. The radiation detector of claim 1, wherein said glass has nanocrystalline particles therein substantially all of which are hexagonal phase.

7. The radiation detector of claim 1, wherein said glass has nanocrystalline particles therein having average diameters of less than about 100 nanometers (nm).

8. The radiation detector of claim 1, wherein said glass has nanocrystalline particles therein having average diameters of less than about 20 nm.

9. The radiation detector of claim 1, wherein a neutron moderator is present between said glass and a source of neutrons.

10. The radiation detector of claim 9, wherein said neutron moderator is polyethylene.

11. The radiation detector of claim 1, wherein at least some of said glass is in the form of adjacent tiles with material having substantially the same index of refraction between said tiles.

12. The radiation detector of claim 1, wherein said system includes a camera for detecting optical events resulting from incident neutrons and/or electromagnetic energy impinging said glass.

13. The radiation detector of claim 12, and further including a reflector on one side of said glass.

14. The radiation detector of claim 13, wherein said reflector is a dielectric.

15. The radiation detector of claim 1, wherein said glass is a transparent ZBLAN heavy metal fluoride glass with not less than about 35 mole % Zr fluoride.

16. The radiation detector of claim 1, wherein said glass includes an arcuate portion.

17. A glass ceramic material which scintillates upon incident neutrons and/or electromagnetic energy of at least 1 keV comprising a fluoride glass matrix having nanocrystalline particles distributed therein.

18. The glass ceramic material of claim 17, wherein said nanocrystalline particles have average diameters less than about 100 nm.

19. The glass ceramic material of claim 17, wherein said nanocrystalline particles have average diameters less than about 20 nm.

20. The glass ceramic material of claim 17, wherein said fluoride glass matrix contains at least 35 mole % Zr ions together with ions selected from the group consisting of alkali and alkaline earth ions, at least 5 mole % of the fluoride ions replaced by Br and/or Cl ions, and at least 0.1 mole % cations present are selected from the group consisting of transition metal ions, rare earth metal ions, Al, Sn, Bi, In ions, Ga ions, Tl ions, Pb ions and mixtures thereof.

21. The glass ceramic material of claim 17, wherein said fluoride glass matrix contains lithium 6 ions.

22. The glass ceramic of claim 17, wherein said glass is a transparent ZBLAN heavy metal fluoride glass with not less than about 35 mole % Zr fluoride.

23. The glass ceramic of claim 22, wherein a light sensitive rare earth element is present therein.

24. The glass ceramic of claim 23, wherein said light sensitive rare earth element is one or more of Eu, Sm Ce, La and mixtures thereof.

25. The glass ceramic of claim 24, wherein said rare earth is Eu present at a concentration of not less than about 0.1 mole %.

26. The glass ceramic of claim 17, wherein said glass ceramic is transparent.

27. A method for making a glass-ceramic material containing nano-crystalline particles with average diameters of less than about 100 nm in a fluorozirconate matrix, comprising mixing ZrF₄, an alkali fluoride, an alkaline earth fluoride, a fluoride of a tri-valent metal selected from the group consisting of transition metal ions, rare earth metal ions, In ions, Ga ions, Tl ions, Pb ions and mixtures thereof, together with a bromide compound selected from the group consisting of alkali and alkaline earth bromides, such that zirconium fluoride is present in a concentration of at least 35 mol % and bromide ions are present in a concentration of at least 5 mol % in the glass-ceramic, heat treating the fluorozirconate matrix at a temperature and for a time sufficient such that substantially all of the nano-crystalline particles are in a phase that scintillates, and thereafter cooling the mixture to room temperature.
